(19) United States
(12) Patent Application Publication
(10) Pub. No.: US 2011/0151704 A1
(43) Pub. Date: Jun. 23, 2011

(54) ANTI-EXTRACTION DEVICE FOR CONNECTORS

(76) Inventor: Li-Fen LIAO, Taichung City (TW)

(21) Appl. No.: 12/642,819

(22) Filed: Dec. 20, 2009

(51) Int. Cl. H01R 4/00

(52) U.S. Cl. 439/345

(57) ABSTRACT

An anti-extraction device for connectors, including two identical latch members that are mated with each other to enclose two coaxially connected connectors of different cables and restrict the connectors from axially displacing. Each latch member has a body section defining a cavity axially extending between two ends of the body section. Two narrowed openings are formed at two ends of the body section in communication with the cavity. A first engaging section and a second engaging section complementary thereto are disposed on two sides of the body section. After the latch members are mated, the cavities together form a chamber for accommodating the connectors therein. Also, the narrowed openings together form two narrowed passages at two ends of the chamber for the cables to pass through. The narrowed passages have a diameter smaller than that of the connectors for restricting the connectors in the chamber without detaching from each other.

### BACKGROUND OF THE INVENTION

The present invention relates generally to a cable connection technique, and more particularly to an anti-extraction device for connectors.

Anti-extraction devices are widely applied to various cables in different fields for extension of the cables or avoiding detachment between serially connected connectors of different cables. For example, an anti-extraction device is applicable to the connectors of the cables of computer peripheral equipments or medical appliances to provide anti-extraction effect and ensure connection between different equipments.

FIGS. 1 and 2 show a conventional anti-extraction sleeve 1, which is used to enclose the connected connectors of different cables and ensure that the connectors keep connected with each other. The anti-extraction sleeve 1 includes a female buckle with a latch notch 3 and a male buckle with a latch bolt 2. The female buckle is pivotally mounted on a pivot shaft 4 for latching the latch bolt 2 in the latch notch 3 so as to provide anti-extraction effect for the connectors. Such anti-extraction sleeve 1 is only applicable to those connectors with structures adapted to the anti-extraction sleeve 1. In other words, the conventional anti-extraction sleeve 1 cannot be applied to most of the existent connectors to provide anti-extraction effect for the connectors.

### SUMMARY OF THE INVENTION

It is therefore a primary object of the present invention to provide an anti-extraction device for connectors. The anti-extraction device is applicable to most of the existent cable connectors to provide anti-extraction effect for the connectors without specific limitation.

To achieve the above and other objects, then anti-extraction device for connectors of the present invention includes two identical latch members. The latch members are mated with each to enclose coaxially serially connected connectors of different cables for restricting the connectors from axially displacing relative to each other. Each latch member has a body section with a predetermined length. The body section defines a cavity having a predetermined diameter. The cavity extends along an axis of the body section between two ends thereof. Two narrowed openings are respectively formed at two axial ends of the body section in communication with the cavity. The narrowed openings have a diameter smaller than that of the cavity. The latch member further includes a first engaging section and a second engaging section complementary to the first engaging section. The first and second engaging sections are respectively disposed on the middles of two lateral sides of the cavity. With the cavities of the latch members face-to-face with each other, the two latch members are complementarily mated with each other to engage the first and second engaging sections of one latch member with the first and second engaging sections of the other latch member. The cavities of the two latch members together form a chamber for accommodating the coaxially serially connected connectors therein. The narrowed openings together form two narrowed passages at two ends of the chamber for the different cables to pass through. The narrowed passages have a diameter smaller than that of the connectors so that the connectors are restricted and located in the chamber to avoid detachment between the connectors and achieve an anti-extraction effect for the connectors.

The present invention can be best understood through the following description and accompanying drawings, wherein:

### BRIEF DESCRIPTION OF THE DRAWINGS

FIG. 1 is a perspective view of a conventional anti-extraction sleeve;

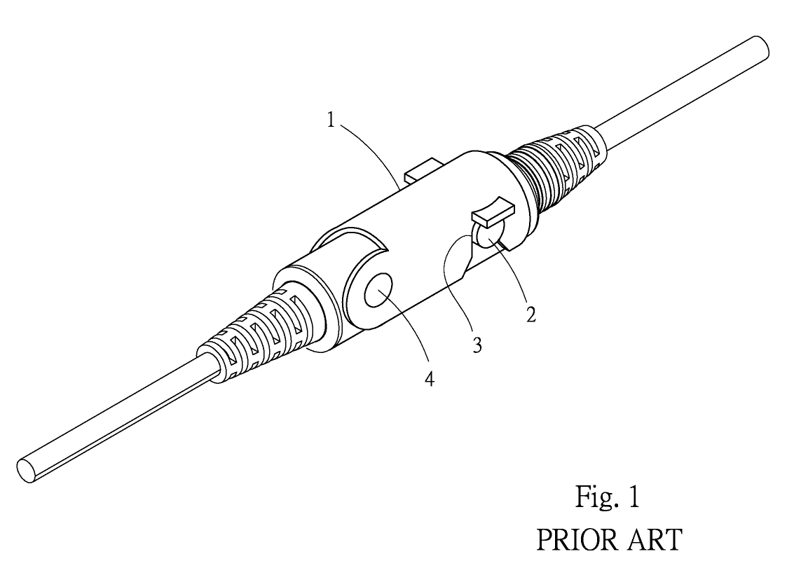

FIG. 2 is a side view of the conventional anti-extraction sleeve, showing the use thereof;

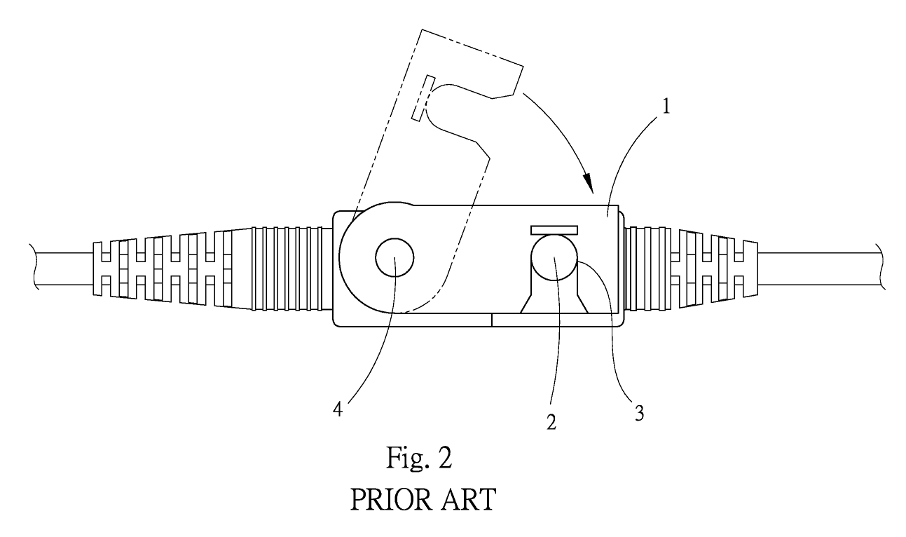

FIG. 3 is a perspective view of the one-piece latch member of a preferred embodiment of the anti-extraction device of the present invention;

FIG. 4 is a perspective exploded view of the preferred embodiment of the anti-extraction device of the present invention, showing that the identical latch members are to be mated to hold the cable connectors;

FIG. 5 is a perspective assembled view of the preferred embodiment of the anti-extraction device of the present invention, showing that the identical latch members have been mated to hold the connected cable connectors;

FIG. 6 is a sectional view taken along line a-a of FIG. 5; and

FIG. 7 is a sectional view taken along line b-b of FIG. 5.

### DETAILED DESCRIPTION OF THE PREFERRED EMBODIMENT

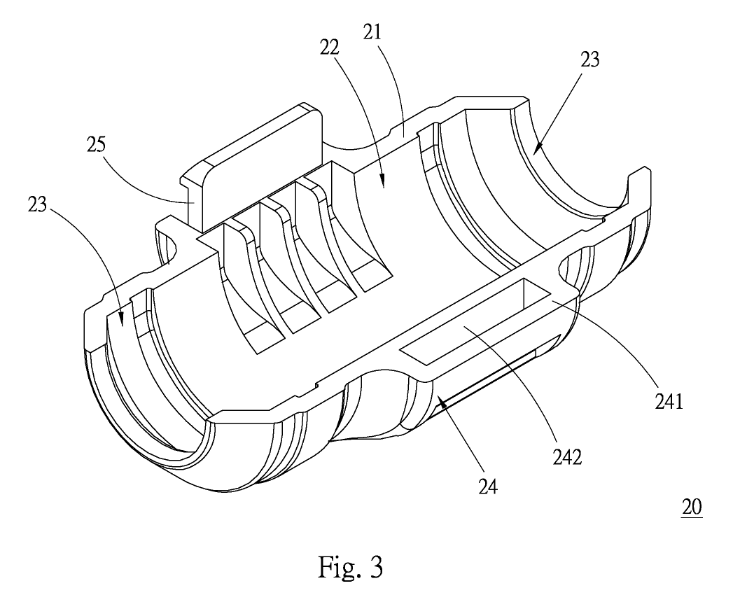

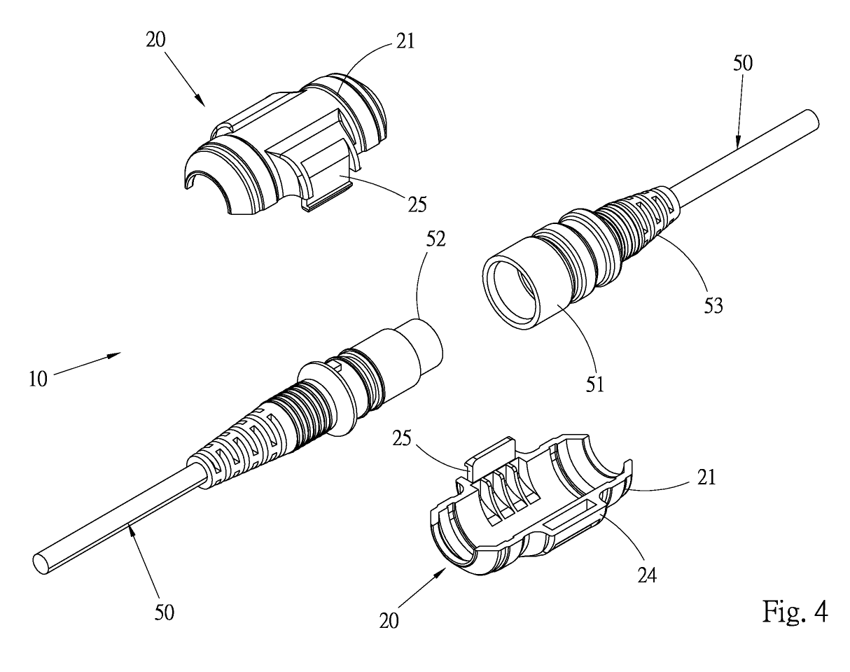

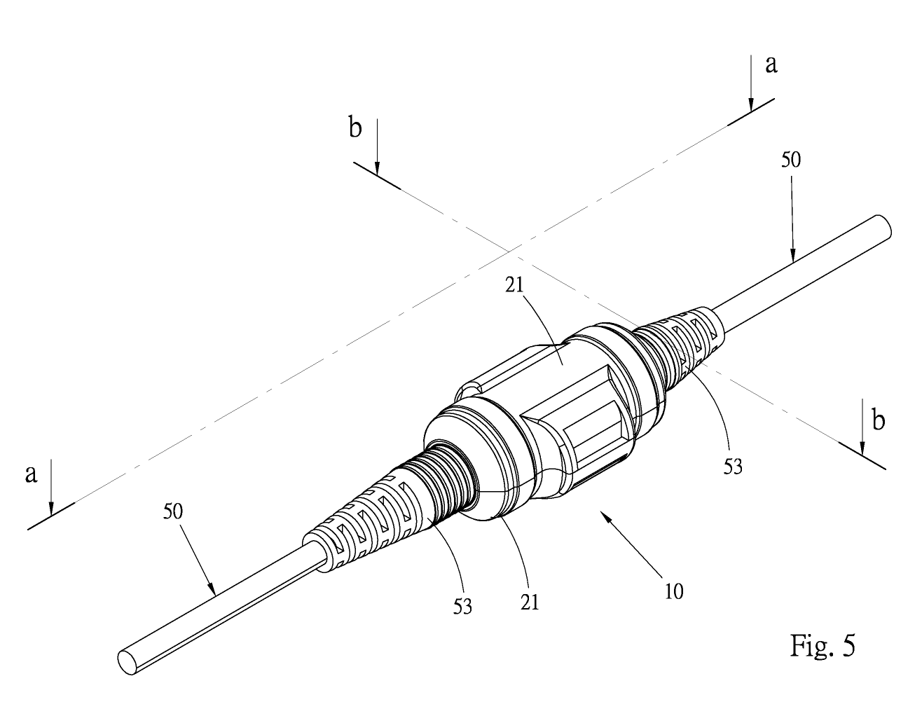

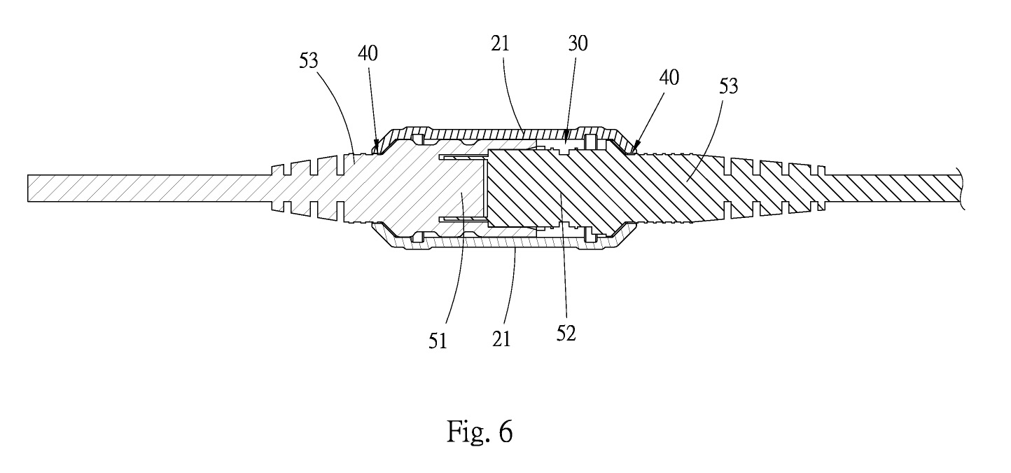

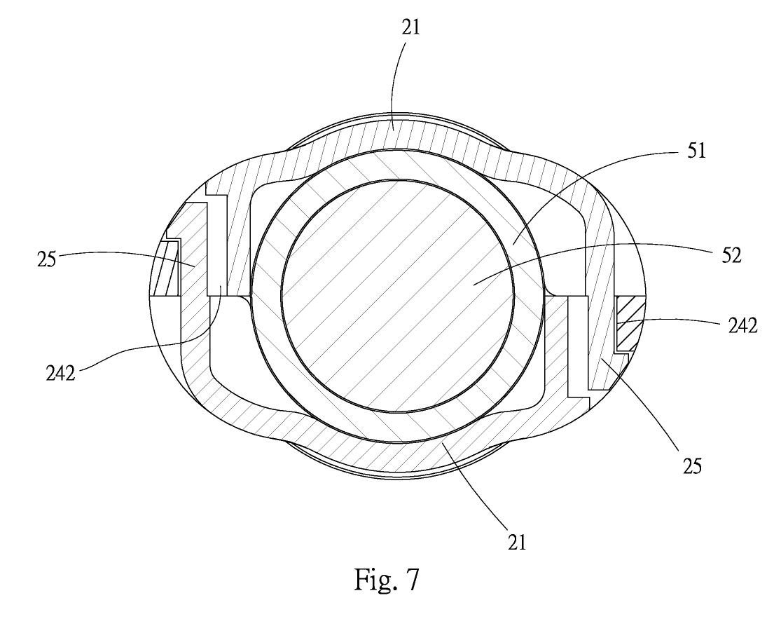

Please refer to FIGS. 3 to 7. According to a preferred embodiment, the anti-extraction device 10 for connectors of the present invention includes two latch members 20 with the same structure. The latch members 20 are mated with each other to form the anti-extraction device 10. Each latch member 20 is a one-piece member integrally made by molding. The latch member 20 has an elongated body section 21, which is a substantially semi-tubular piece with an arc-shaped, and preferably semicircular, cross section normal to an axis of the body section 21.

The semi-tubular body section 21 defines a cavity 22, which has an open upper side. The cavity 22 extends along the axis of the body section 21 between two ends thereof.

Two narrowed openings 23 with open upper sides are respectively formed at two axial ends of the body section 21 in communication with the cavity 22. The narrowed openings 23 have a diameter smaller than that of the cavity 22. The open upper sides of the narrowed openings 23 are flush with the open upper side of the cavity 22.

A first engaging section 24 with a wing plate 241 is disposed on the body section 21 and protrudes therefrom. The wing plate 241 outward extends from the middle of a lateral side of the open upper side of the cavity 22. An elongated insertion slot 242 is formed through the wing plate 241. The insertion slot 242 has a length parallel to an axis of the cavity 22.

A second engaging section 25 is disposed on the body section 21. The second engaging section 25 has a bar-shaped insertion body 251 complementary to the insertion slot 242. The insertion body 251 outward extends from the middle of the other lateral side of the open upper side of the cavity 22. The insertion body 251 has a length parallel to the axis of the cavity 22.

In use of the anti-extraction device 10, with the open upper sides of the cavities 22 face-to-face with each other, the two latch members 20 are complementarily mated with each other. At this time, the insertion body 251 of the second engaging section of one latch member is inserted into the insertion slot 242 of the first engaging section of the other latch member, whereby the two latch members 20 are fixedly engaged with each other. Also, the cavities 22 of the two latch members 20 together form a chamber 30 and the narrowed openings 23 together form two narrowed passages 40 at two axial ends of the body section 21. The narrowed passages 40 have a diameter smaller than that of the chamber 30. Accordingly, the serially connected connectors 51, 52 of different cables 50 can be accommodated in the chamber 30, permitting the cable sections 53 of the cables 50 to outward pass through the narrowed passages 40. The diameter of the narrowed passages 40 is smaller than the diameter of the connectors 51, 52 so that the connectors 51, 52 are restricted and located in the chamber 30. Under such circumstance, the connectors 51, 52 are prevented from axially displacing relative to each other so as to avoid detachment between the connectors 51, 52. Therefore, the anti-extraction device 10 is able to provide an anti-extraction effect for the connectors 51, 52.

The latch members 20 of the anti-extraction device 10 have totally identical structures and very small volume. Therefore, the anti-extraction device 10 can be manufactured at lower cost. Moreover, the anti-extraction device 10 is applicable to most of the existent cable connectors without any other adaptive structure thereof. Also, the anti-extraction device 10 is composed of two identical latch members 20 latched with each other. Therefore, the anti-extraction device 10 can be readily used without the problem of stocking. In contrast, when using the conventional anti-extraction device, it is necessary to inconveniently choose the male buckle and female buckle adapted thereto. In other words, the present invention is characterized in that each latch member has both male and female buckle structures complementary to each other. Therefore, the male and female buckle structures of a first latch member can be engaged with the female and male buckle structures of an identical second latch member, which is positioned in reverse to the first latch member. Accordingly, the latch members can be firmly mated with each other with double latching effects. Therefore, the anti-extraction device 10 of the present invention can overcome the problems existing the prior art to ensure that the connectors of the cables keep securely connected with each other without being extracted.

The above embodiment is only used to illustrate the present invention, not intended to limit the scope thereof. Many modifications of the above embodiment can be made without departing from the spirit of the present invention.

What is claimed is:

1. An anti-extraction device for connectors, comprising two identical latch members, the latch members being mated with each to enclose coaxially serially connected connectors of different cables for restricting the connectors from axially displacing relative to each other, each latch member having a body section with a predetermined length, the body section defining a cavity having a predetermined diameter, the cavity extending along an axis of the body section between two ends thereof, two narrowed openings being respectively formed at two axial ends of the body section in communication with the cavity, the narrowed openings having a diameter smaller than that of the cavity, the latch member further including a first engaging section and a second engaging section complementary to the first engaging section, the first and second engaging sections being respectively disposed on the middles of two lateral sides of the cavity, whereby with the cavities of the latch members face-to-face with each other, the two latch members are complementarily mated with each other to engage the first and second engaging sections of one latch member with the first and second engaging sections of the other latch member, the cavities of the two latch members together forming a chamber for accommodating the coaxially serially connected connectors therein, the narrowed openings together forming two narrowed passages at two ends of the chamber for the different cables to pass through, the narrowed passages having a diameter smaller than that of the connectors so that the connectors are restricted and located in the chamber to avoid detachment between the connectors and achieve an anti-extraction effect for the connectors.

2. The anti-extraction device for connectors as claimed in claim 1, wherein the first engaging section has a wing plate disposed on one side of the body section and protruding therefrom, an insertion slot being formed through the wing plate, the insertion slot having a length parallel to an axis of the cavity, the second engaging section being disposed on another side of the body section, the second engaging section having an insertion body complementary to the insertion slot, the insertion body protruding from the other side of the body section and extending by a predetermined length in a direction parallel to the axis of the cavity.
